(19) United States
(12) Patent Application Publication
(10) Pub. No.: US 2025/0369691 A1
(43) Pub. Date: Dec. 4, 2025

(54) Portable Hunting And Camping Kit

(71) Applicant: Austin Holmstrom, Rice Lake, WI (US)

(72) Inventor: Austin Holmstrom, Rice Lake, WI (US)

(21) Appl. No.: 18/732,233

(22) Filed: Jun. 3, 2024

(51) Int. Cl. F26B 21/00; A47L 23/20; F26B 3/06; H02J 7/35

(52) U.S. Cl. CPC F26B 21/008; A47L 23/205; F26B 3/06; H02J 7/35

(57) ABSTRACT

A portable hunting and camping kit includes a rechargeable power assembly and a drying assembly. The rechargeable power assembly includes solar panels and a power unit, wherein the power unit includes a battery and power outlets detachably connectable to powered devices for charging or operation. The drying assembly includes a pair of drying units insertable into wet or damp objects, a control unit, a pair of cables connecting the pair of drying units to the control unit, and a power cable detachably connecting the control unit to one of the power outlets.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hunting and camping tools and accessories and more particularly pertains to a new portable hunting and camping kit that includes a solar power unit to provide power for electronic and electric devices, which kit also includes a drying assembly to drying out clothing, footwear, sleeping bags, and other items that might get wet or damp during a hunting or camping trip in the outdoors.

### (2) Description of Related Art Including Information Disclosed Under 37 CFR 1.97 and 1.98

The prior art relates to hunting and camping tools and accessories. The prior art, as best understood, does not disclose a portable hunting and camping kit that includes a portable boot and glove dryer, or a sleeping bag heater, which is powered by a solar-chargeable battery.

### Brief Summary of the Invention

An embodiment of the disclosure meets the needs presented above in a portable hunting and camping kit generally comprising a rechargeable power assembly and a drying assembly. The power assembly includes solar panels and a power unit, wherein the power unit includes a battery and power outlets detachably connectable to powered devices for charging or operation. The drying assembly includes a pair of drying units insertable into wet or damp objects, a control unit, a pair of cables connecting the pair of drying units to the control unit, and a power cable detachably connecting the control unit to one of the power outlets.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a portable hunting and camping kit according to an embodiment of the disclosure.

FIG. 2 is a rear view of an embodiment of the disclosure.

FIG. 3 is a close-up view of a portion of an embodiment of the disclosure.

FIG. 4 is a close-up view of a portion of an embodiment of the disclosure.

FIG. 5 is a front view of an embodiment of the disclosure in use.

FIG. 6 is a block diagram showing the relationship of components of an embodiment of the disclosure.

### DETAILED DESCRIPTION OF THE INVENTION

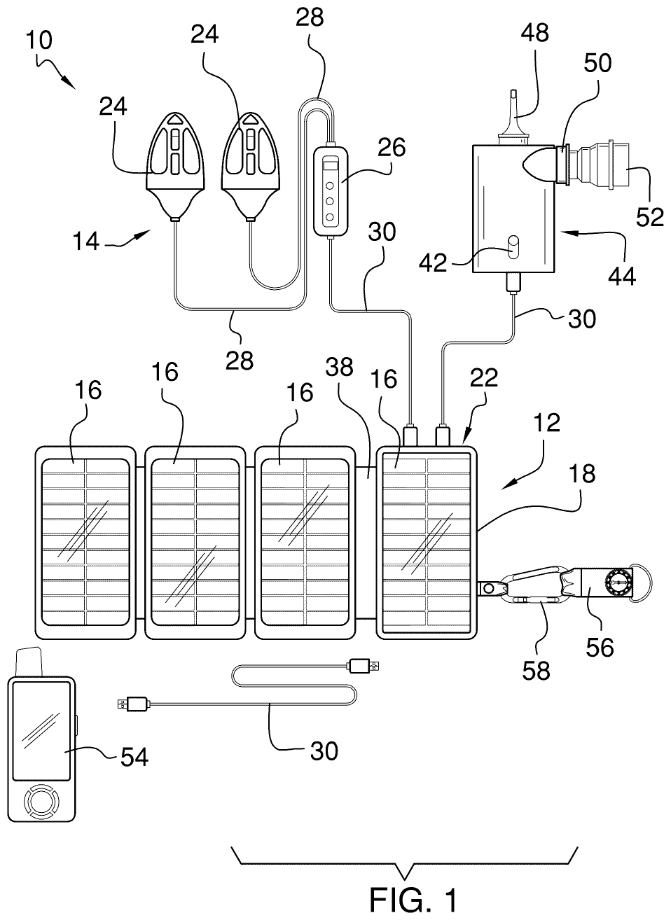

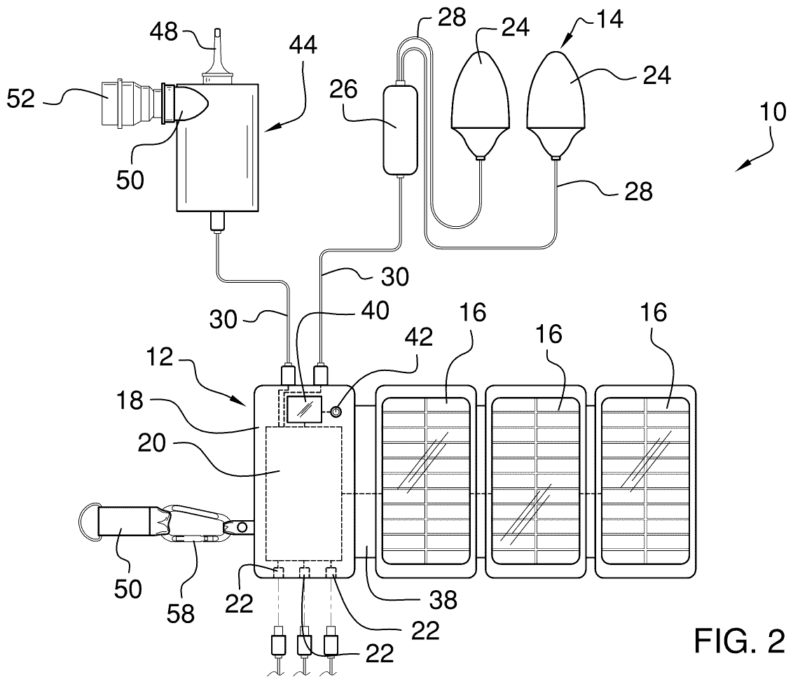

With reference now to the drawings, and in particular to FIGS. 1 through 6 thereof, a new portable hunting and camping kit embodying the principles and concepts of an embodiment of the disclosure and generally designated by the reference numeral 10 will be described.

As best illustrated in FIGS. 1 through 6, the portable hunting and camping kit 10 generally comprises a rechargeable power assembly 12 and a drying assembly 14. The rechargeable power assembly 12 includes solar panels 16 and a power unit 18, wherein the power unit 18 includes a battery 20 and power outlets 22 detachably connectable to powered devices for charging or operation. The drying assembly 14 includes a pair of drying units 24 insertable into wet or damp objects, a control unit 26, a pair of cables 28 connecting the pair of drying units 24 to the control unit 26, and a power cable 30 detachably connecting the control unit 26 to one of the power outlets 22.

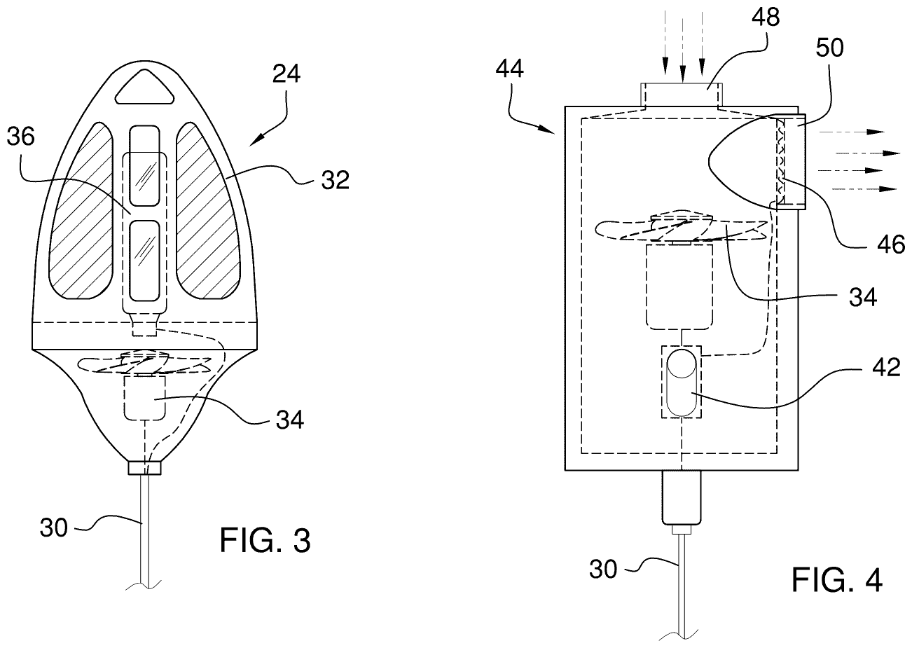

As best shown in FIGS. 3 and 4, each of the pair of drying units 24 includes a vented housing 32 and a powered fan 34 therein to circulate air. In one possible embodiment, the vented housing 32 has an arched or rounded conical profile with a minimal thickness sufficient to fit into footwear, though other shapes such as ovals or circles could be utilized for the vented housing 32. Each of the pair of drying units 24 can include a light unit 36, such as an LED light, to indicate operating status of its corresponding drying unit 24. For example, the light unit 36 could turn on to show that the drying unit 24 is active, and turn off when the drying unit 24 is inactive.

The power assembly 12 includes a flexible structure 38 connecting the solar panels 16 to the power unit 18, such as a flexible strip of material such as cloth, fabric, or plastic. The solar panels 16 are positioned spaced apart on the flexible structure 38 to permit folding up and stacking of the solar panels 16 and the power unit 18 in a compact state. In the embodiment shown in FIG. 1, three solar panels 16 are connected to the flexible structure 38, and one more solar panel 16 is mounted on the power unit 18, though more or fewer solar panels 16 could be included or arranged in a different configuration. In one possible embodiment, the power unit 18 also includes a flashlight 40, which can be turned on and off by a power button 42. In one possible embodiment, the power outlets 22 are in the form of USB receptacles, though other types of connections are within the scope of the disclosure.

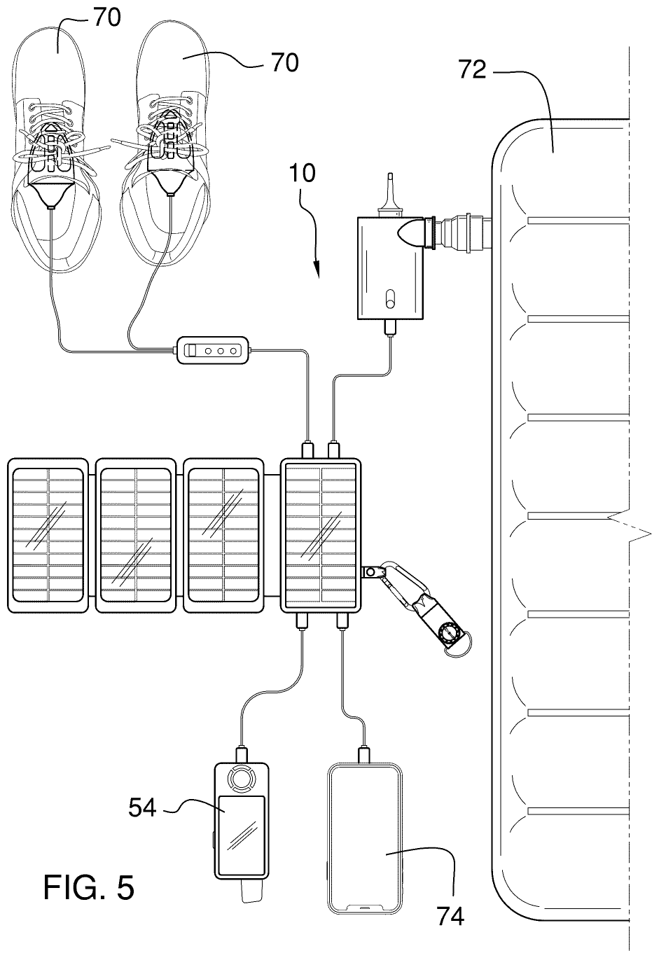

In one possible embodiment, the portable hunting and camping kit 10 further includes a blower unit 44 detachably connected to one of the power outlets 22. The blower unit 44 includes a heating element 46 to heat air passing through the blower unit 44. The blower unit 44 includes an intake port 48, a discharge port 50, and a powered fan 34 to conduct air through the blower unit 44. The blower unit 44 can also include at least one fitting 52 to detachably connect the blower unit 44 to an object to be inflated or deflated. For example, the fitting 52 could be designed to connect to a port of an inflatable sleeping mattress 72, such as shown in FIG. 5. The blower unit 44 also includes a power button 42 or switch to turn it on and off.

In one possible embodiment, the portable hunting and camping kit 10 further includes a GPS unit 54 detachably connected to one of the power outlets 22. In one possible embodiment, the portable hunting and camping kit 10 further includes a compass 56 detachably connected to the power unit 18, such as by a carabiner 58. Other accessories suitable for hunting and camping, such as electric lighters, audio or visual emergency locating devices, and other such devices could be included in the kit and are within the scope of the disclosure.

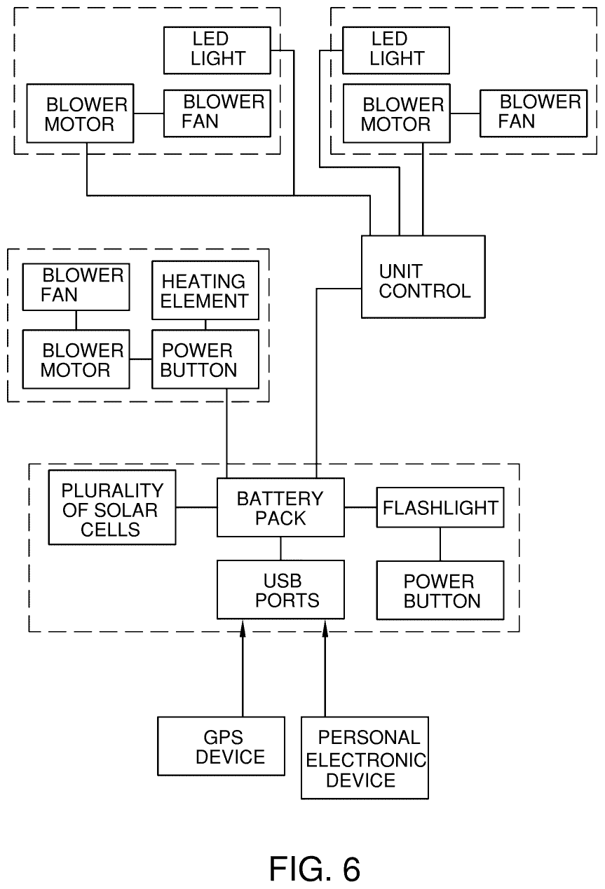

FIG. 6 is a block diagram showing a possible arrangement and relationship of components of the portable hunting and camping kit 10 according to one possible embodiment.

With reference to FIG. 5, the portable hunting and camping kit 10 has many uses, though the first step is to charge the battery 20 of the power unit 18 via the solar panels 16. The user can then hook up a powered device to the power unit 18, which can be done whether the battery 20 is sufficiently charged or not, provided that there is sufficient solar power available to supply a sufficient charge to operate a powered device. One of the main uses is for drying damp or wet objects that could become damp or wet during outdoor activities or as the result of inclement weather. To do so, the user detachably connects the power cable 30 of the drying assembly 14 to one of the power outlets 22. The user then inserts the pair of drying units 24 into the wet or damp objects, and then activates the pair of drying units 24 and to dry out the objects. The objects could be most anything, though the pair of drying units 24 are most suitable for drying a pair of footwear, such as boots 70 shown in FIG. 5, as well as shoes and socks, which very often become damp or wet during hunting or camping. The drying units 24 could also be used to dry clothing, such as gloves, shirts, pants, and headwear, as well as other items such as sleeping bags, backpacks, bags, or other camping gear. The control unit 26 can be used to control the operation of the drying units 24, such as turning the drying units 24 on and off and adjusting the speed of the powered fan 34.

If the portable hunting and camping kit 10 further includes a heated blower unit 44, the user can use the heated blower unit 44 to inflate an inflatable sleeping mattress 72, such as shown in FIG. 5, or for other purposes where blown air would be useful, such as blowing air on campfire coals or wood to help start or maintain a fire, or blowing warming air into a sleeping bag to help keep the user warm in cold weather. If the portable hunting and camping kit 10 further includes the GPS unit 54, this can also be connected to the power unit 18. The power outlets 22 can be connected to most any power device for charging or operation, such as a cell phone or smartphone 74 or other personal electronic or electric device, as shown in FIG. 5.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable hunting and camping kit comprising:
a rechargeable power assembly comprising solar panels and a power unit, wherein said power unit comprises a battery and power outlets detachably connectable to powered devices for charging or operation; and
a drying assembly comprising a pair of drying units insertable into wet or damp objects, a control unit, a pair of cables connecting said pair of drying units to said control unit, and a power cable detachably connecting said control unit to one of said power outlets.

2. The portable hunting and camping kit of claim 1, wherein each of said pair of drying units comprises a vented housing and a powered fan therein to circulate air.

3. The portable hunting and camping kit of claim 2, wherein said vented housing has an arched or rounded conical profile with a minimal thickness sufficient to fit into footwear.

4. The portable hunting and camping kit of claim 3, wherein each of said pair of drying units comprises a light unit to indicate operating status of its corresponding drying unit.

5. The portable hunting and camping kit of claim 1, wherein said rechargeable power assembly comprises a flexible structure connecting said solar panels to said power unit.

6. The portable hunting and camping kit of claim 5, wherein said solar panels are disposed spaced apart on said flexible structure to permit folding up and stacking of said solar panels and said power unit in a compact state.

7. The portable hunting and camping kit of claim 1, wherein said power unit comprises a flashlight.

8. The portable hunting and camping kit of claim 1, wherein each of said power outlets comprises a USB receptacle.

9. The portable hunting and camping kit of claim 1, further comprising a blower unit detachably connected to one of said power outlets.

10. The portable hunting and camping kit of claim 9, wherein said blower unit comprises a heating element to heat air passing through said blower unit.

11. The portable hunting and camping kit of claim 10, wherein said blower unit comprises an intake port, a discharge port, and a powered fan to conduct air through said blower unit.

12. The portable hunting and camping kit of claim 11, wherein said blower unit comprises at least one fitting to detachably connect said blower unit to an object to be inflated or deflated.

13. The portable hunting and camping kit of claim 1, further comprising a GPS unit detachably connected to one of said power outlets.

14. The portable hunting and camping kit of claim 1, further comprising a compass detachably connected to said power unit.

15. A method of using the portable hunting and camping kit of claim 1, comprising the steps of:
charging said battery of said power unit via said solar panels;
detachably connecting said power cable of said drying assembly to one of said power outlets;
inserting said pair of drying units into wet or damp objects; and
activating said pair of drying units and drying out the objects.

16. The method of claim 15, wherein said step of inserting said pair of drying units comprises inserting said pair of drying units one each into a pair of footwear including socks, shoes, and boots.

17. The method of claim 15, wherein said step of inserting said pair of drying units comprises inserting said pair of drying units into clothing.

18. The method of claim 15, wherein said step of inserting said pair of drying units comprises inserting said pair of drying units one each into a sleeping bag or other camping gear.

19. The method of claim 15, wherein the portable hunting and camping kit further comprises a heated blower unit detachably connected to one of said power outlets, and said method further comprises using said heated blower unit to at least one of:
inflate an inflatable sleeping mattress,
blow air on campfire coals or wood, and
blow warming air into a sleeping bag.

20. A portable hunting and camping kit comprising:
a rechargeable power assembly comprising solar panels and a power unit, wherein said power unit comprises a battery and power outlets detachably connectable to powered devices for charging or operation, wherein:
said rechargeable power assembly comprises a flexible structure connecting said solar panels to said power unit, and said solar panels are disposed spaced apart on said flexible structure to permit folding up and stacking of said solar panels and said power unit in a compact state,
said power unit comprises a flashlight;
a drying assembly comprising a pair of drying units insertable into wet or damp objects, a control unit, a pair of cables connecting said pair of drying units to said control unit, and a power cable detachably connecting said control unit to one of said power outlets, wherein:
each of said pair of drying units comprises a vented housing and a powered fan therein to circulate air, and said vented housing has an arched or rounded conical profile with a minimal thickness sufficient to fit into footwear,
each of said pair of drying units comprises a light unit to indicate operating status of its corresponding drying unit;
a blower unit detachably connected to one of said power outlets, wherein:
said blower unit comprises a heating element to heat air passing through said blower unit,
said blower unit comprises an intake port, a discharge port, and a powered fan to conduct air through said blower unit,
said blower unit comprises at least one fitting to detachably connect said blower unit to an object to be inflated or deflated;
a GPS unit detachably connected to one of said power outlets; and
a compass detachably connected to said power unit.
